(19) United States
(12) Patent Application Publication
(10) Pub. No.: US 2016/0075115 A1
(43) Pub. Date: Mar. 17, 2016

(54) POLYOLEFIN-BASED FIBER-REINFORCED RESIN MULTILAYERED SHEET AND METHOD FOR MANUFACTURING THE SAME

(71) Applicants: Panasonic Corporation, Osaka (JP); KURASHIKI BOSEKI KABUSHIKI KAISHA, Kurashiki-shi (JP)

(72) Inventors: Hideo MINE, Nara (JP); Kazuyuki HARADA, Osaka (JP); Masashi TANAKA, Osaka (JP); Takashi KANDA, Osaka (JP); Eiichiro HAGINOYA, Osaka (JP)

(21) Appl. No.: 14/839,568

(22) Filed: Aug. 28, 2015

(30) Foreign Application Priority Data
Sep. 12, 2014 (JP) 2014-186918
Sep. 14, 2014 (JP) 2014-186915

(51) Int. Cl. B32B 27/12; B32B 7/12; B32B 37/08; B32B 27/32; B32B 37/06; B32B 37/10; B32B 5/02; B32B 27/08

(52) U.S. Cl. CPC B32B 27/12; B32B 5/024; B32B 7/12; B32B 27/08; B32B 27/32; B32B 37/06; B32B 37/10; B32B 37/08; B32B 2250/05; B32B 2250/242; B32B 2250/40; B32B 2262/0253; B32B 2262/12

(57) ABSTRACT

A polyolefin-based fiber-reinforced multilayered sheet of the present invention includes woven fabric layers layered via bonding layers on both surfaces of a core layer, wherein the core layer is made of at least one resin selected from the group consisting of a resin mainly made of polypropylene and a homopolymer polypropylene resin, the woven fabric layers are formed from yarns containing a composite fiber in which a first component is polypropylene and a second component is a polyolefin component having a melting point lower than that of the first component, the bonding layers are thermoadhesive polyolefin-based films, and a cover layer is layered on a surface of one of the woven fabric layers. Accordingly, a polyolefin-based fiber-reinforced resin multilayered sheet that is free from delamination, is light, has a high physical strength against flexure, is inexpensive, has a sense of three-dimensionality, and is amenable to integration with another part by injection molding, and a method for manufacturing the same, are provided.

### BACKGROUND OF THE INVENTION

1. Field of the Invention

The present application relates to a polyolefin-based fiber-reinforced resin multilayered sheet that has a sense of three-dimensionality and is amenable to integration with another part by injection molding, and a method for manufacturing the same.

2. Description of Related Art

Conventionally, a multilayered body is known that is formed by layering a plurality of fiber-reinforced woven fabrics using carbon fibers, aramid fibers, or the like, or that is integrated with a foam sheet or the like. JP 2012-096482A has proposed a multilayered sheet in which a carbon fiber woven fabric layer is integrated with a surface of a core layer made of foam. Furthermore, a multilayered body also has been proposed in which a carbon fiber woven fabric and an aramid fiber woven fabric are integrated using a polycarbonate film as a bonding layer (JP H5-117411A). Furthermore, it also has been proposed to layer unidirectional fibrous members on both surfaces of a hollow core (JP 2009-000933A). These multilayered bodies are advantageous in that they are light and have a high flexural strength.

However, conventional multilayered bodies are problematic in that the cost is high because expensive materials such as carbon fibers, aramid fibers, or hollow cores are used.

### SUMMARY OF THE INVENTION

In order to solve the conventional problem, the present invention provides a polyolefin-based fiber-reinforced resin multilayered sheet that is free from delamination, is light, has a high physical strength against flexure, is inexpensive, has a sense of three-dimensionality, and is amenable to integration with another part by injection molding, and a method for manufacturing the same.

The present invention is directed to a polyolefin-based fiber-reinforced resin multilayered sheet including woven fabric layers layered via bonding layers on both surfaces of a core layer, wherein the core layer is made of at least one resin selected from the group consisting of a resin mainly made of polypropylene and a homopolymer polypropylene resin, the woven fabric layers are formed from yarns containing a composite fiber in which a first component is polypropylene and a second component is a polyolefin component having a melting point lower than that of the first component, the bonding layers are thermoadhesive polyolefin-based films, and a cover layer is layered on a surface of one of the woven fabric layers.

The present invention is further directed to a method for manufacturing the polyolefin-based fiber-reinforced resin multilayered sheet, including: layering a woven fabric, via a film for bonding, on both surfaces of a core sheet; and layering a cover layer on a surface of one of the woven fabrics, performing heating and pressing, and then performing cooling.

The present invention is further directed to another method for manufacturing the polyolefin-based fiber-reinforced resin multilayered sheet, including: layering a woven fabric, via a film for bonding, on a sheet for a cover layer and on both surfaces of a core sheet, performing heating and pressing, and then performing cooling.

According to the present invention, all of the core layer, the bonding layers, the woven fabric layers, and the cover layer forming the fiber-reinforced resin multilayered sheet are made of an olefin-based resin. Thus, it is possible to provide a multilayered sheet that is inexpensive, and, at the same time, is free from delamination, is light, has a high physical strength against flexure, and has a sense of three-dimensionality and a good appearance. This multilayered sheet is thermoplastic, and is suitable for vacuum molding, press molding, bend molding using thermal deformation, and the like. Furthermore, the woven fabric layers are bonded to the core layer via the thermoadhesive polyolefin-based films, and fibers forming the woven fabrics do not shrink even in the subsequent molding with the application of heat. Thus, a molded body is obtained in which attractive weave patterns of the woven fabrics appear as they are on the surfaces of the multilayered sheet. In addition, since one of the outermost layers of the multilayered sheet is formed as a woven fabric layer, a multilayered sheet can be provided in which another part can be integrated by injection molding with this woven fabric layer.

### BRIEF DESCRIPTION OF THE DRAWINGS

FIG. 1 is a schematic cross-sectional view of a multilayered sheet according to an embodiment of the present invention.

FIG. 2 is a schematic cross-sectional view showing an apparatus for manufacturing multilayered sheets in the embodiment of the present invention.

FIG. 3 is a schematic perspective view of a molded body obtained by performing vacuum molding on the multilayered sheet according to the embodiment of the present invention.

### DESCRIPTION OF THE PREFERRED EMBODIMENT

A fiber-reinforced resin multilayered sheet of the present invention includes a fiber-reinforced layer in which woven fabric layers are attached via bonding layers to both surfaces of a core layer. The core layer is made of at least one resin selected from the group consisting of a resin mainly made of polypropylene and a homopolymer polypropylene resin. This core layer is layered in the form of a sheet or a film. A resin mainly made of polypropylene is advantageous in that it provides satisfactory physical properties in practice and is inexpensive. The term “being mainly made of” refers to the state in which, when the total resin component is taken as 100 mol %, the propylene unit is 50 mol % or more. Homopolymer polypropylene (HPP) is advantageous in that it has a high hardness with a melting point of about 160° C., provides satisfactory physical properties in practice, and is inexpensive, and, furthermore, can prevent the occurrence of sink marks, wrinkles, and the like in subsequent molding with the application of heat. Note that the fiber-reinforced resin multilayered sheet may be referred to simply as a multilayered sheet.

The core layer may be made of a propylene-ethylene random copolymer (RPP). RPP is a random copolymer with a propylene unit of 50 mol % or more and an ethylene unit of 50 mol % or less, has a melting point of 135 to 150° C., and is generally commercially available. RPP is advantageous in that it is excellent in thermal adhesiveness. The core layer has a thickness of preferably 0.1 to 2 mm, and more preferably 0.2 to 1.5 mm.

As the core layer, a non-foam polypropylene-based sheet is preferably used. A core layer using a non-foam polypropylene-based sheet does not collapse even with press molding, and is easily subjected to vacuum molding, bend molding using thermal deformation, and the like.

The composite fiber constituting the woven fabric layers is preferably a core-sheath composite fiber in which a first component is a core and a second component is a sheath. Specifically, the woven fabric layers are preferably formed from yarns containing a core-sheath composite fiber in which the core component is polypropylene and the sheath component is a polyolefin-based component having a melting point lower than that of the core component. When the sheath component is a polyolefin-based component having a low melting point, it is easily thermally bonded. Furthermore, when thermoadhesive polyolefin-based films are used as the bonding layers, the core layer and the woven fabric layers can be bonded by the application of heat and pressure, and, thus, the layers are easily integrated.

It is preferable that the core component of the core-sheath composite fiber is homopolymer polypropylene, and that the sheath component is a propylene-ethylene random copolymer (RPP), a polypropylene-polyethylene blend, or a polyethylene resin. With this structure, thermal bonding can be more easily performed.

The thermoadhesive polyolefin-based film is preferably low-density polyethylene (LLDPE) or RPP. LLDPE and RPP are excellent in thermal processability, bonding properties, and transparency.

The woven fabrics may have any structure, such as plain, twill (twill weave), satin, or any other variations. The yarns forming the woven fabrics are preferably multifilament or monofilament yarns having a single fiber fineness of 1 to 10 dtex and a total fineness of 1000 to 3000 dtex. The woven fabrics preferably have a weight per unit area of 50 to 500 g/m².

In the multilayered sheet of the present invention, a cover layer is integrally layered on one of the surfaces of the fiber-reinforced layer. The cover layer preferably has a transparency that allows the woven fabric layer to be seen from the outside. If the woven fabric layer can be seen from the outside, the multilayered sheet looks very strong and can maintain a good appearance. In this sense, the cover layer may be referred to as an optical cover layer. The cover layer is preferably formed from a polypropylene-based resin sheet transparent layer, a coloring layer, and a polypropylene-based resin sheet protective layer. In this transparent cover layer, the polypropylene-based resin sheet transparent layer is preferably a relatively thick sheet, for example, having a thickness of 100 to 300 μm, and preferably 150 to 250 μm. With this structure, a sense of three-dimensionality and a thick appearance can be provided.

The polypropylene-based resin sheet transparent layer is preferably made of a blend or a polymer alloy of homopolymer polypropylene (HPP) and propylene-ethylene random copolymer (RPP). If the transparent layer is taken as 100% by weight, the homopolymer polypropylene (HPP) and the propylene-ethylene random copolymer (RPP) are contained in a ratio of preferably HPP:RPP=50:50 to 90:10, and more preferably HPP RPP=60:40 to 80:20. With such a ratio, both high transparency derived from the amorphous nature of the random polypropylene (RPP) and high abrasion resistance derived from the homopolymer polypropylene (HPP) can be exhibited.

A coloring layer is preferably provided on the transparent layer. This coloring layer is for realizing a good appearance on the outer face, and is preferably formed by lightly applying a color coating agent so as to maintain the transparency. The coloring layer has a thickness of preferably 0.1 to 2 μm, and more preferably 0.2 to 1 μm. The color of the coloring layer can be freely selected. A propylene-based resin sheet protective layer is preferably provided on the coloring layer. This protective layer is preferably a biaxial oriented polypropylene-based resin sheet. The biaxial oriented polypropylene-based resin sheet is preferable because of its high abrasion resistance. The biaxial oriented polypropylene-based resin sheet has a thickness of preferably 5 to 50 μm, and more preferably 10 to 40 μm.

According to the present invention, the polypropylene-based resin sheet transparent layer, the coloring layer, and the polypropylene-based resin sheet protective layer are layered preferably via bonding layers on one of the surfaces of the fiber-reinforced layer. The woven fabric layer is seen through the thick transparent layer from the outside, and well-structured and attractive weave patterns appear as they are on the surface of the multilayered sheet. The other surface is a woven fabric layer, and, thus, when integrating another part by injection molding with this woven fabric layer, the part is easily integrated by injection molding with the woven fabric surface because the surface has a rough face. Since the woven fabric layers are not deformed by heat, problems such as sink marks and wrinkles can be suppressed. As a result, a multilayered sheet is obtained that is excellent in the appearance such as gloss or coloring.

Furthermore, in the multilayered sheet of the present invention, a multiaxial oriented fiber sheet may be added between the core layer and the woven fabric layers. The multiaxial oriented fiber sheet may be a product with brand name “Kuramas” manufactured by Kurabo Industries Ltd. For example, the multiaxial oriented fiber is a multiaxial oriented fiber sheet having directions of 0°/+60°/−60° and a weight per square meter (weight per unit area) of 350 g/m², and formed using a large number of PP filaments having a total fineness of 1850 dtex, and polyethylene terephthalate yarns as stitch yarns.

For example, a method for manufacturing the multilayered sheet of the present invention includes: in a state where a polypropylene-based resin sheet transparent layer, a coloring layer, and a polypropylene-based resin sheet protective layer are integrally layered in advance, arranging a core layer, films for bonding on both surfaces thereof, and woven fabric layers on both surfaces thereof, via a film for bonding on a surface of the transparent layer; performing heating and pressing; and then performing cooling. The reason why a polypropylene-based resin sheet transparent layer, a coloring layer, and a polypropylene-based resin sheet protective layer are integrally layered in advance is to improve the efficiency in the last layering process. In the heating and pressing process, the atmosphere temperature is preferably 120 to 150° C., and more preferably 130 to 145° C. The pressure is preferably approximately 1 MPa. The heating time is preferably 0.5 to 5 minutes, and more preferably 1 to 4 minutes. The cooling process is performed preferably for 0.5 to 5 minutes, and more preferably for 1 to 4 minutes. The cooling process is performed preferably until the temperature reaches approximately 30° C. or less.

After the shaping, the multilayered sheet has a total thickness of preferably 0.5 to 5 mm, more preferably 0.8 to 4 mm, and particularly preferably 0.9 to 1.6 mm. With such a thickness, the weight can be reduced, and the appearance can be improved. Furthermore, the layer thicknesses of the core layer, each of the woven fabric layers, and the cover layer are preferably in a relationship of core layer>woven fabric layer>cover layer. With such a relationship, the weight can be reduced, and the appearance can be improved.

The manufacturing method of the present invention is not limited to a continuous method, and the manufacture can be performed also using a method that performs heating and pressing, and cooling each time. This method is sufficient for producing samples or performing manufacture on a small scale. The continuous method is preferable for mass production.

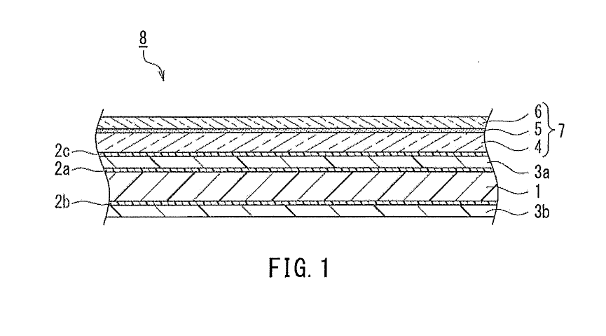

Next, a description will be given with reference to the drawings. In the drawings, the same reference numerals refer to the same constituent elements. FIG. 1 is a schematic cross-sectional view of a multilayered sheet according to an embodiment of the present invention. In a multilayered sheet 8, woven fabric layers 3a and 3b are integrally attached via bonding layers 2a and 2b to both surfaces of a core layer 1. A polypropylene-based resin transparent layer 4, a coloring layer 5, and a polypropylene-based resin protective layer 6 are integrally layered via a bonding layers 2c on a surface of the woven fabric layer 3a. Note that the polypropylene-based resin transparent layer 4, the coloring layer 5, and the polypropylene-based resin protective layer 6 may be integrally layered in advance as a cover layer 7.

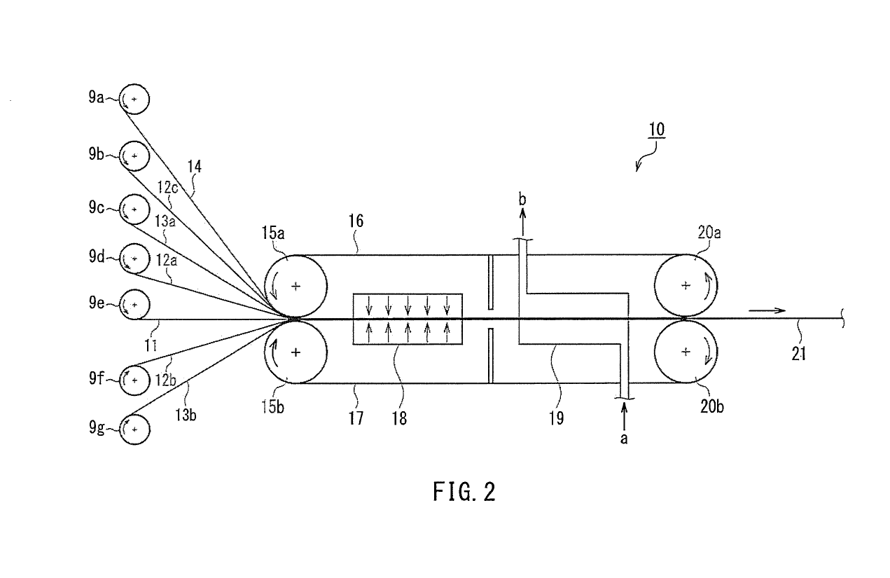

FIG. 2 is a schematic cross-sectional view showing an apparatus 10 for manufacturing multilayered sheets in the embodiment of the present invention. The apparatus 10 for manufacturing multilayered sheets is configured by material sheet supply rolls 9a to 9g, a heating and pressing region 18, and a cooling region 19, and can perform continuous production. First, a core sheet 11 is supplied from the supply roll 9e, films 12a and 12b for bonding are supplied from the supply rolls 9d and 9f, woven fabrics 13a and 13b are supplied from the supply rolls 9c and 9g, a film 12c for bonding is supplied from the supply roll 9b, and a sheet 14 for a cover layer is supplied from the supply roll 9a, all of which are layered between pressure rolls 15a and 15b. The pressure rolls 15a and 15b and pressure rolls 20a and 20b are combined with metal pressure plates 16 and 17 in endless forms. First, pressing and heating are performed in the heating and pressing region 18. Next, in the cooling region 19, cooling air is supplied in the direction of arrow a and is discharged in the direction of arrow b, so that cooling is performed. In order to efficiently perform cooling, cooling is performed by arranging a water-cooling pipe in the cooling region 19 in addition to the cooling air. A multilayered sheet 21 taken out from the pressure rolls 20a and 20b is cut into pieces each having a predetermined length.

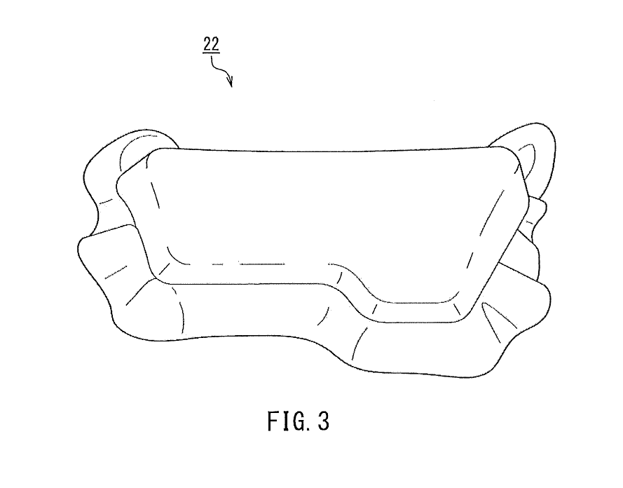

FIG. 3 is a schematic perspective view of a molded body 22 obtained by performing vacuum molding on the multilayered sheet according to the embodiment of the present invention. The molded body 22 has a maximum width of 260 mm, a maximum depth of 170 mm, and a height of 500 mm. The multilayered sheet is advantageous in that it can be subjected to deep drawing. Furthermore, this multilayered sheet is on the whole made of a thermoplastic resin, can be subjected to vacuum molding, press molding, bend molding using thermal deformation, and the like, and realizes a short molding cycle and a low production cost. In addition, when integrating another part by injection molding with the woven fabric layer 3b in FIG. 1, the part is easily integrated by injection molding with the woven fabric surface because the surface has a rough face. Since the woven fabric layers are not deformed by heat, problems such as sink marks and wrinkles can be suppressed.

### EXAMPLES

Hereinafter, the present invention will be described more specifically by way of examples. Note that the present invention is not limited to the following examples.

Method for Measuring Flexural Modulus of Elasticity and Flexural Stress

The measurement was performed using the three point flexural test as defined in JIS K 7171. A specimen had sizes of a width of 20 mm and a length of 50 mm, and the test speed was set to 1 mm/min. A pressure jig had a shape of R5, each of supports had a shape of R2, and a gap between the supports was set to 24 mm.

Gloss and Hardness

The gloss of molded bodies was judged by visually inspecting the appearances. A molded body with gloss was judged as “A”, a molded body whose gloss was somewhat insufficient was judged as “B”, and a molded body without gloss was judged as “C”. Regarding the hardness of molded bodies, a molded body whose hardness was sufficient in practice was judged as “A”, and a molded body whose hardness was somewhat insufficient was judged as “B”. Note that the hardness was not evaluated in the case where the woven fabric was disposed on a surface.

### Example 1

### Core Layer

As the core layer 1 shown in FIG. 1, a commercially available homopolymer polypropylene (HPP) sheet having a melting point of 160° C., a thickness of 500 μm, and a weight per unit area of 450 g/m² was used.

Woven Fabric

As the woven fabric layers 3a and 3b shown in FIG. 1, a core-sheath composite fiber in which the core component was polypropylene having a melting point of 160° C. and the sheath component was a polypropylene-polyethylene blend (melting point 110° C.) was used. This composite fiber had a composite ratio of core component 65 wt %:sheath component 35 wt %. The number of the fibers used was 240, and the total fineness was 1850 dtex. The core-sheath composite fiber yarns were subjected to a fusing process, and used as warp and weft yarns to form a woven fabric having a twill structure. The woven fabric thus obtained had a weight per unit area of 190 g/m².

Bonding Film

As the bonding layers 2a, 2b, and 2c shown in FIG. 1, a commercially available low-density polyethylene (LLDPE) film having a melting point of 110° C., a thickness of 30 μm, and a weight per unit area of 27 g/m² was used.

Cover Layer

As the cover layer 7 shown in FIG. 1, a cover layer 7 was used in which a homopolymer polypropylene (HPP) sheet 4 having a thickness of 200 μm, a coloring layer 5 obtained by performing coating with a color coating agent to a thickness of 1 μm, and a homopolymer polypropylene (HPP) biaxial oriented sheet 6 having a thickness of 25 μm were integrally layered in advance.

Manufacture of Multilayered Sheet

On both surfaces of the core sheet 11 shown in FIG. 2, the bonding films 12a and 12b, the woven fabrics 13a and 13b were layered in this order, and, furthermore, on the surface of the woven fabric 13a, the bonding film 12c and the sheet 14 for a cover layer were layered in this order. The obtained layers were subjected to press molding at a temperature of 145° C. and a pressure of 1 MPa for 2 minutes, and were then cooled down to room temperature (27° C.). Accordingly, the bonding films were caused to adhere to adjacent layers so that the entirety was integrated to form a multilayered sheet. A schematic cross-sectional view of this multilayered sheet is as shown in FIG. 1.

The flexural modulus of elasticity and the flexural stress of each obtained multilayered sheet are listed in Table 1. The gloss, the hardness, and the appearance were evaluated using molded bodies after another part was integrated thereto by injection molding. In the Examples, another part was integrated by injection molding to the woven fabric layer 13b positioned on the side opposite from the cover layer.

### Example 2

This example was the same as Example 1, except that a sheet (thickness 200 μm) made of a blend or a polymer alloy of homopolymer polypropylene (HPP) and propylene-ethylene random copolymer (RPP) in a ratio of HPP:RPP=75:25 was used as the transparent layer 4 of the cover layer 7 shown in FIG. 1. The physical properties of the obtained multilayered sheet are listed in Table 1.

### Example 3

This example was the same as Example 1, except that a sheet (thickness 200 μm) made of a blend or a polymer alloy of homopolymer polypropylene (HPP) and propylene-ethylene random copolymer (RPP) in a ratio of HPP:RPP=25:75 was used as the transparent layer 4 of the cover layer 7 shown in FIG. 1. The physical properties of the obtained multilayered sheet are listed in Table 1.

### Example 4

This example was the same as Example 1, except that a sheet (thickness 200 μm) made of a propylene-ethylene random copolymer (RPP) was used as the transparent layer 4 of the cover layer 7 shown in FIG. 1. The physical properties of the obtained multilayered sheet are listed in Table 1.

### Comparative Example 1

This example was the same as Example 1, except that no cover layer in Example 1 was provided, and that a layer (thickness 200 μm, weight per unit area 180 g/m²) made of a blend of 25 wt % of homopolymer polypropylene (HPP, melting point 160° C.) and 75 wt % of propylene-ethylene random copolymer (RPP, melting point 145° C.) was disposed as the outermost layer, via the bonding film described in Example 1, on the outer surface of the woven fabric layer with which another part was to be integrated by injection molding. Note that another part was integrated by injection molding with the surface of the outermost layer. The physical properties of the obtained multilayered sheet are listed in Table 1. Data of the flexural modulus of elasticity and the flexural stress in each example is data in MD (length direction).

TABLE 1

| | Flexural | | | | |
|---|---|---|---|---|---|
| | modulus of | Flexural | | | |
| | elasticity | stress | | | Sense of three- |
| | (GPa) | (MPa) | Hardness | Gloss | dimensionality |
| Ex. 1 | 2.2 | 57 | A | B | Three-dimensional |
| Ex. 2 | 2.5 | 62 | A | A | Three-dimensional |
| Ex. 3 | 2.3 | 60 | B | A | Three-dimensional |
| Ex. 4 | 2.1 | 58 | B | A | Three-dimensional |
| Com. | 2.0 | 57 | — | C | Not three- |
| Ex. 1 | | | | | dimensional |

As clearly seen from Table 1, the products according to Examples of the present invention were multilayered sheets that had a high flexural modulus of elasticity, high flexural stress, and a high hardness, were free from delamination, were light, had a high physical strength against flexure, had a sense of three-dimensionality, and were glossy. These multilayered sheets were thermoplastic and suitable for vacuum molding, press molding, bend molding using thermal deformation, and the like, so that molded bodies were obtained at a low cost. Furthermore, the woven fabric layers were bonded via the thermoadhesive polyolefin-based films to the core layer, and fibers forming the woven fabrics did not shrink even in the subsequent molding with the application of heat, and, thus, molded bodies were obtained in which attractive weave patterns of the woven fabrics appeared as they were on the surfaces of the multilayered sheet. In addition, it was seen that, since one of the faces of the multilayered sheet was formed as a woven fabric layer, when integrating a rib part by injection molding with this woven fabric layer, the part was easily integrated by injection molding with the woven fabric surface because the surface had a rough face, and problems such as sink marks and wrinkles were suppressed.

On the other hand, since the product according to Comparative Example 1 had no cover layer, the sense of three-dimensionality and the gloss were insufficient.

### Example 5

### Core Layer

As the core layer 1 shown in FIG. 1, a commercially available homopolymer polypropylene (HPP) sheet having a melting point of 160° C., a thickness of 500 μm, and a weight per unit area of 450 g/m² was used.

Woven Fabric

As the woven fabric layers 3a and 3b shown in FIG. 1, a core-sheath composite fiber in which the core component was polypropylene having a melting point of 160° C. and the sheath component was a polypropylene-polyethylene blend (melting point 110° C.) was used. This composite fiber had a composite ratio of core component 65 wt %:sheath component 35 wt %. The number of the fibers used was 240, and the total fineness was 1850 dtex. The core-sheath composite fiber yarns were subjected to a fusing process, and used as warp and weft yarns to form a woven fabric having a twill structure. The woven fabric thus obtained had a weight per unit area of 190 g/m².

Bonding Film

As the bonding layers 2a, 2b, and 2c shown in FIG. 1, a commercially available low-density polyethylene (LLDPE) film having a melting point of 110° C., a thickness of 30 μm, and a weight per unit area of 27 g/m² was used.

Cover Layer

As the cover layer 7 shown in FIG. 1, a cover layer 7 was used in which a sheet 4 (thickness 200 μm) made of a blend or a polymer alloy of homopolymer polypropylene (HPP) and propylene-ethylene random copolymer (RPP) in a ratio of HPP:RPP=75:25, a coloring layer 5 obtained by performing coating with a color coating agent to a thickness of 1 μm, and a homopolymer polypropylene (HPP) biaxial oriented sheet 6 having a thickness of 25 μm were integrally layered in advance.

Manufacture of Multilayered Sheet

On both surfaces of the core sheet 11 shown in FIG. 2, the bonding films 12a and 12b, the woven fabrics 13a and 13b were layered in this order, and, furthermore, on the surface of the woven fabric 13a, the bonding film 12c and the sheet 14 for a cover layer were layered in this order. The obtained layers were subjected to press molding at a temperature of 145° C. and a pressure of 1 MPa for 2 minutes, and were then cooled down to room temperature (27° C.). Accordingly, the bonding films were caused to adhere to adjacent layers so that the entirety was integrated to form a multilayered sheet. A schematic cross-sectional view of this multilayered sheet is as shown in FIG. 1. The flexural modulus of elasticity and the flexural stress of each obtained multilayered sheet are listed in Table 2.

Another part was integrated by injection molding with the woven fabric layer 13b of the obtained multilayered sheet. At that time, it was checked whether or not the cover layer side had problems such as sink marks and wrinkles. The result is shown in Table 2.

### Comparative Example 2

This example was the same as Example 1, except that propylene-ethylene random copolymer (RPP) was used as the core layer 1 shown in FIG. 1. Another part was integrated by injection molding with the obtained multilayered sheet. At that time, it was checked whether or not the cover layer side had problems such as sink marks and wrinkles. The result is shown in Table 2.

TABLE 2

| | Flexural | Flexural | Sink marks or wrinkles |
|---|---|---|---|
| | modulus of | stress | occurred during injection |
| | elasticity (GPa) | (MPa) | molding? |
| Ex. 5 | 2.5 | 62 | Did not occur |
| Com. Ex. 2 | 2.2 | 60 | Somewhat occurred |

As clearly seen from Table 2, the product according to Example of the present invention had a high flexural modulus of elasticity and high flexural stress, was free from delamination, and did not have problems such as sink marks or wrinkles. This multilayered sheet was thermoplastic and suitable for vacuum molding, press molding, bend molding using thermal deformation, and the like, so that a molded body was obtained at a low cost. Furthermore, the woven fabric layers were bonded via the thermoadhesive polyolefin-based films to the core layer, and fibers forming the woven fabrics did not shrink even in the subsequent molding with the application of heat, and, thus, a molded body was obtained in which attractive weave patterns of the woven fabrics appeared as they were on the surfaces of the multilayered sheet. In addition, it was seen that, since one of the faces of the multilayered sheet was formed as a woven fabric layer, when integrating a rib part by injection molding with this woven fabric layer, the part was easily integrated by injection molding with the woven fabric surface because the surface had a rough face, and, since the woven fabric layers were not deformed by heat, problems such as sink marks and wrinkles were suppressed.

On the other hand, when a rib part was integrated by injection molding with the product according to Comparative Example 2, sink marks were somewhat seen on the cover layer side.

Molded bodies using the multilayered sheet of the present invention are applicable to consumer multilayered products, such as automobile parts, automobile interior parts, household electric appliances, medical protectors, suitcases, containers, shelves, pallets, panels, bags, sleeve boxes for automated warehouses, doors, elongated boxes for collecting rolls, core materials of tatami (Japanese floor mats), wall materials for exhibition booths, T-boards (buffer plates for trucks), table and chair sets, and the like.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. A polyolefin-based fiber-reinforced resin multilayered sheet including woven fabric layers layered via bonding layers on both surfaces of a core layer,
wherein the core layer is made of at least one resin selected from the group consisting of a resin mainly made of polypropylene and a homopolymer polypropylene resin,
the woven fabric layers are formed from yarns containing a composite fiber in which a first component is polypropylene and a second component is a polyolefin component having a melting point lower than that of the first component,
the bonding layers are thermoadhesive polyolefin-based films, and
a cover layer is layered on a surface of one of the woven fabric layers.

2. The polyolefin-based fiber-reinforced resin multilayered sheet according to claim 1, wherein the cover layer includes a polypropylene-based resin sheet transparent layer, a coloring layer, and a polypropylene-based resin protective layer.

3. The polyolefin-based fiber-reinforced resin multilayered sheet according to claim 1, wherein the cover layer has a transparency that allows the woven fabric layer to be seen from the outside.

4. The polyolefin-based fiber-reinforced resin multilayered sheet according to claim 1, wherein the resin mainly made of polypropylene, of the core layer, is a propylene-ethylene random copolymer containing 50 mol % or more of propylene.

5. The polyolefin-based fiber-reinforced resin multilayered sheet according to claim 1, wherein the composite fiber is a core-sheath composite fiber in which a first component is a core and a second component is a sheath.

6. The polyolefin-based fiber-reinforced resin multilayered sheet according to claim 5, wherein the core component of the core-sheath composite fiber is homopolymer polypropylene, and the sheath component is a propylene-ethylene random copolymer or a polypropylene-polyethylene blend.

7. The polyolefin-based fiber-reinforced resin multilayered sheet according to claim 1, wherein the thermoadhesive polyolefin-based films are low-density polyethylene films.

8. The polyolefin-based fiber-reinforced resin multilayered sheet according to claim 2, wherein the polypropylene-based resin sheet transparent layer of the cover layer is made of a blend of homopolymer polypropylene and random polypropylene.

9. The polyolefin-based fiber-reinforced resin multilayered sheet according to claim 2, wherein the polypropylene-based resin sheet transparent layer of the cover layer is made of a blend containing homopolymer polypropylene (HPP) and propylene-ethylene random copolymer (RPP) in a ratio of HPP:RPP=50:50 to 90:10 when the transparent layer is taken as 100% by weight.

10. The polyolefin-based fiber-reinforced resin multilayered sheet according to claim 2, wherein the protective layer of the cover layer is a biaxial oriented polypropylene-based resin sheet.

11. The polyolefin-based fiber-reinforced resin multilayered sheet according to claim 1, wherein the polyolefin-based fiber-reinforced resin multilayered sheet has a total thickness of 0.9 to 1.6 mm.

12. The polyolefin-based fiber-reinforced resin multilayered sheet according to claim 1, wherein layer thicknesses of the core layer, each of the woven fabric layers, and the cover layer are in a relationship of core layer>woven fabric layer>cover layer.

13. A method for manufacturing the polyolefin-based fiber-reinforced resin multilayered sheet according to claim 1, comprising:
layering a woven fabric, via a film for bonding, on both surfaces of a core sheet; and
layering a cover layer on a surface of one of the woven fabrics, performing heating and pressing, and then performing cooling.

14. A method for manufacturing the polyolefin-based fiber-reinforced resin multilayered sheet according to claim 1, comprising:
layering a woven fabric, via a film for bonding, on a sheet for a cover layer and on both surfaces of a core sheet, performing heating and pressing, and then performing cooling.
